(19) United States
(12) Patent Application Publication
(10) Pub. No.: US 2009/0261125 A1
(43) Pub. Date: Oct. 22, 2009

(54) CONTAINER INCLUDING VALVE ASSEMBLY FOR STORING LIQUIDS CONTAINING SOLIDS

(76) Inventors: Hans-Peter WILD, Eppelheim (DE); Rudolf KASPER, Eppelheim (DE); Christoph HESSENAUER, Nussloch (DE)

Correspondence Address: STROOCK & STROOCK & LAVAN LLP, 180 MAIDEN LANE, NEW YORK, NY, 10038, US

(21) Appl. No.: 12/424,975

(22) Filed: Apr. 16, 2009

(30) Foreign Application Priority Data
Apr. 16, 2008 (DE) 102008019142.6

(51) Int. Cl. B67D 5/06; B67D 3/00; F16K 21/00

(52) U.S. Cl. 222/195; 222/557; 137/527

(57) ABSTRACT

A container for storing a liquid containing solids such as food products that includes a shut off assembly is provided. The container includes sidewalls and a funnel shaped bottom wall that defines an outlet for the liquid containing solids to be removed from the container. The shut off assembly is positioned at the outlet to open and close the outlet to permit the liquids containing solids to be stored in the container and to be opened to permit the solids to be removed from the container. A shut off assembly is provided at the outlet for providing a source of compressed air through the shut off assembly to effect mixing of the liquid containing solids stored in the container when the shut off assembly is in a closed position so that when the liquid containing solids is removed from the container it is homogenously mixed.

### FIELD OF THE INVENTION

The present invention relates generally to a container and valve assembly for storing a liquid containing solids and in particular, a valve assembly for a container that permits air to be introduced through the valve assembly to establish effective mixing of the liquid and solids prior to the mixed liquid being emptied from the container.

### BACKGROUND OF THE INVENTION

Certain liquids that contain a considerable proportion of solids such as beverages and food products in the food industry are stored and transported as concentrates and mixed with water for manufacturing finished beverages. When these types of liquids mixed with solids are stored in a container, because of gravity, the heavier solid particles get deposited in the lower region of the container and the liquid tends to separate from the solids. Nevertheless, when these types of liquids are to be removed from the container it is important that they be homogenously mixed. One way of achieving such mixing is to place a valve in the container so that you can blow air into the valve to stir up the solids and cause mixing. One such container having a valve that permits mixing of the liquid containing the solids is described in German Patent Application No. DE 198 25 611A. The problem with this arrangement is that product residue will penetrate behind the valve and get stuck there during the closing of the gas inlet valve. Such complex valve structures are difficult to clean and hence, cause hygiene problems when transporting food products.

Reference is also made to German Patent Application No. DE 1 269 097, wherein an assembly for pneumatically mixing and conveying materials that have a tendency to harden from withstanding pressure in a pressurized container is described. The pressurized container includes an outlet conduit in which a three-way tap is arranged for shutting off the outlet flow of the materials from the pressure container. There is an assembly for thorough mixing of two separate sources of compressed gas. A first gas is introduced via a closed circular pipeline around the lower area of the pressure container of the pressurized container in communication with inlet nozzles. The compressed air is introduced into the interior of the container through the inlet nozzles, where this step can be accomplished with the shut off valve being opened or with the shut off valve being closed. The second flow path for the compressed air runs through a three-way cap but by reason of its configuration, it can only be opened when the flow path of the liquid is closed at the outlet. Such a system is not only complex but is not particularly suitable for food processing because it permits the ingress and egress of contaminants which are of concern in food handling.

Still another approach to handling liquids containing solids and in particular food products of this type is described in German Patent Application No. DE 1 550 409, wherein a butterfly valve is used to throttle or shut off the flow of liquid in a pipeline. A butterfly valve can be rotated about its axis, and a flow path in the liquid extends through the butterfly valve to define an outlet channel. This outlet channel will form another flow path out of the pipeline to automatically perform opening and closing of the pipeline which can prevent critically high water hammers when the valve is closed too fast. However, butterfly valves do not address the problem of introducing a flow path of compressed air into the liquid and solid mixture to effect a homogenous mixing of the two before dispensing the fluid.

### SUMMARY OF THE INVENTION

Generally speaking, in accordance with the invention, a container and valve assembly for storing, handling and removing liquids containing solids that are homogenously mixed is provided. The container includes a sidewall and a funnel shaped bottom wall. The bottom wall forms an outlet for the liquid containing solids to be removed from the container. A shut off assembly is positioned at the outlet for selectively closing the outlet to permit the liquid to remain stored in the container. The shut off assembly can be opened at the outlet to permit a flow path for the liquid and solids to be removed from the container. Compressed air is introduced through the shut off assembly and into the container to effect mixing of the liquid containing the solid when the shut off assembly is positioned in a closed position prior to opening the shut off assembly so that the liquid containing solids is homogenously mixed by the compressed air and then is removed from the container through the shut off assembly after mixing.

In an exemplary embodiment the shut off is a flap valve that includes a closing flap for preventing the liquid from flowing out of the outlet in a closed position and for permitting the liquid to flow through the outlet when the flap is in an open position. The flap is supported by a hollow elongated member that has an input opening for receiving the compressed air and a second opening that is disposed at the flap so that the compressed air can be introduced into the input opening and exits at the second opening in the flap in order to effect mixing of the container throughout the container prior to rotating the flap to an open position to permit the mixed liquid from the container to be removed.

Accordingly it is an object of the invention to provide an improved container and cut off assembly that provides for improved mixing of liquids containing solids prior to their removal from the container.

It is a further objection of the invention to provide an improved valve assembly for a container that permits the valve to open and close the flow path of liquid from a container and further permits a flow path of air to be introduced through the valve to mix the liquid and solids at the outlet of the container.

### BRIEF DESCRIPTION OF THE DRAWINGS

The foregoing summary as well as the following detailed description of the preferred embodiments of the application will be better understood when read in conjunction with the appended drawings. For the purpose of illustrating the devices of the present application there is shown in the drawings preferred embodiments. It should be understood however that the application is not limited to the precise arrangements and instrumentalities shown. In the drawings:

FIG. 1 is a schematic representation of a container and shut off assembly constructed in accordance with the instant invention;

FIG. 2 is a perspective view of a flap valve constructed in accordance with an exemplary embodiment of the instant invention;

FIG. 3 is a planned view of a flap valve constructed in accordance with an exemplary embodiment of the instant invention; and

FIG. 4 is a sectional view constructed in accordance with an exemplary embodiment of the instant invention taken along line A-A of FIG. 3.

### DETAILED DESCRIPTION OF THE PREFERRED EMBODIMENTS

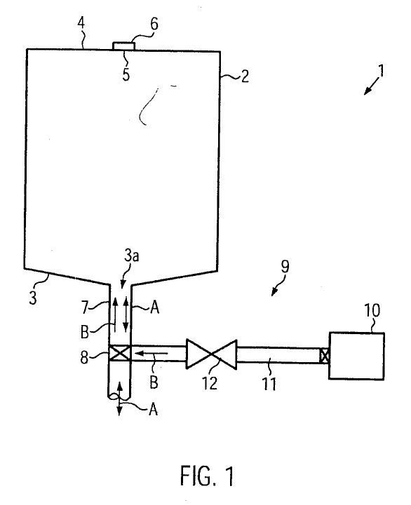

Reference is made to FIG. 1 wherein a schematic representation of a container, generally indicated at 1, is provided for storing liquids that contain solids such as beverages and other food products of the type where the heavy particles tend to separate from the liquid and fall to the bottom of the container during storage. In particular, container 1 is a transport and storage container for a food product such as for example, fruit preparations or beverage preparations, which contain solid particles for example turbid materials or pieces of fruit or the like that can acquiesce or become a paste-like mass. These types of foodstuffs tend to be segregated by gravity, i.e., the heavier particles get deposited in the lower region of the container 1 where they are stored for a relatively long time.

In particular, container 1 includes a sidewall 2 which although usually cylindrically or cuboid can be of any shape. The bottom of the container is formed by a funnel shaped wall 3 and the container is closed at the top by a cover 4 that will often include a vent hole 5 or other pressure reducing opening that usually includes a filter 6 for a container that contain food or other perishable type products. Funnel shaped opening 3 includes an opening 3a at the lowest point in the container through which the ingredient are emptied or withdrawn from the container and also through which the container would be filled. It is noted that in accordance with the instant invention emptying of the container and filling of the container can be accomplished through different openings and that the instant invention is concerned with the bottom of the container being used to empty the liquid and solid mixture that is being stored in the container. Conduit 7 is in fluid communication with opening 3a and includes a shut off assembly 8, which in a preferred embodiment of the instant invention is a valve. Shut off assembly 8 can be arranged at any position in conduit 7, however in an exemplary embodiment the shut off assembly is a valve 8′ (See FIGS. 1, 3 and 4) that would be provided at distance from opening 3a at the bottom of the container to facilitate removal of the valve 8′ for cleaning and maintenance purposes. The entire liquid and solid mixture of the container thus flows through opening 3a in the container in a first flow path A through the outlet conduit 7 and the shut off assembly 8 to a vessel provided downstream of the valve 8 to permit the ingredients to be further processed. A mixing assembly generally indicated at 9 is provided to permit the food and solid mixture to be mixed in the container 1 by introducing compressed gas therein. The mixing assembly includes a source of compressed gas 10 that introduces a flow of compressed gas through a flow path indicated by the arrow B into the interior of the container 1. The flow path includes conduit 11, second shut off valve 12 and shut off assembly 8. In accordance with the invention, the shut off assembly 8 that permits the compressed air 10 to travel through the conduit 11 and shut off valve 12, and through the conduit 7 along flow path B into the container in order to cause the homogenous mixing of the liquids and solids therein. Second short off valve 12 is disposed upstream of the shut off valve assembly to assure that no food particles are cleared from the container on the container side of the shut off valve assembly 8 to assure that there are no contaminants remaining in the container or the valve after mixing. By this configuration all of the ingredients that are disposed above the shut off mechanism will be effected by the compressed air and mixed and swirled thoroughly.

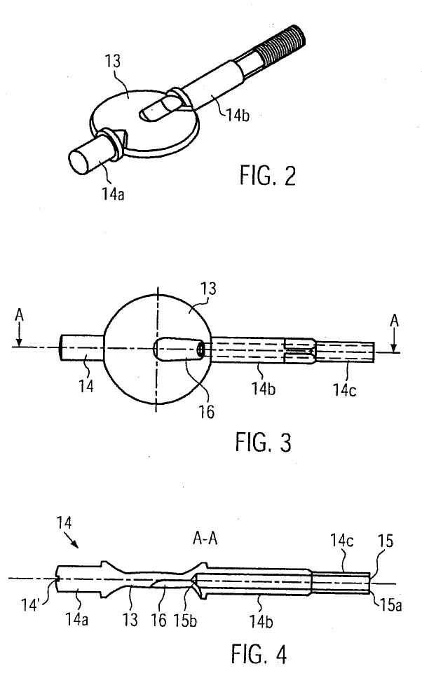

Reference is now made to FIGS. 2 through 4 wherein a shut off valve 8′ that is particularly suitable for use as the shut off valve assembly and is depicted in detail. Valve 8′ is a flap valve that contains a closing flap 13, which is a closing plate with dimensions to be located within the outlet conduit 7 and is dimensioned to seal off the outlet conduit when the valve is disposed in a closed position. Closing flap 13 includes two end shafts 14a and 14b at diametrically opposite sides and are positioned in pivot bearings disposed on the conduit (not shown) to permit the flap member 13 to be rotated between an open and closed position in the conduit 7. As is further depicted in FIG. 3 and FIG. 4 shaft 14b is tubular and has an elongated opening that defines a passage channel 15 along the inside diameter thereof along axis 14 and can be rotated about axis 14.

Accordingly, conduit 15 extends from inlet opening 15a to a connecting pipe 15c for connecting the conduit 11 (e.g. hose) through the shaft end 14e to the region of the closing flap 13 and terminates at an outlet opening 15b. The passage channel is preferably designed as an opening extending along co-axle central line 14. As is depicted in FIGS. 2, 3 and 4, the outlet opening 15b ends at a cavity 16 in a flat side of the flap plate 13, namely the side facing the interior container when the valve is in a closed position.

The configuration of the flap valve 8′ permits the closing flap 13 to be rotated between an open position and a closed position to allow the mixture of ingredients in the container to be removed therefrom. However, when the closing flap 13 is in a closed position, a pressure surge using compressed gas can be introduced into the container by introducing the compressed air through the conduit 15 and cavity 16 into the container when the valve is in a closed position, which causes the ingredients in the container to be mixed thoroughly and to again homogenize and reverse the separation process between the liquid and the solids that was caused by gravity. Simultaneously any ingredients that have possibly penetrated in the conduit 11 downstream of the second shut off valve are blown out of the conduit so that no product residues can collect there and cleaning is facilitated. The excessive pressure is subsequently reduced by the opening 5 and the filter 6 in the cover 4. Although another valve configuration rather than the flap valve 8′ depicted in FIGS. 2 through 4 can be provided, such configuration is required to provide two flow paths, with one being capable of remaining open even if the valve is closed. In this regard, a slide or other type valve may be employed within the spirit of the invention.

While there have been shown and described from the mental novel features of the invention as applied to the preferred and exemplary embodiments thereof, it will be understood that the omission and substitution and changes in the form and details of the disclosed invention may be made by those skilled in the arts without departing from the spirit of the invention. Moreover, as is readily apparent, numerous modifications and changes may readily occur to those skilled in the art. Hence, it is not desired to limit the invention to the exact construction and operation shown and described and, accordingly all suitable modifications and equivalents may be resorted to falling within the scope of the invention as claimed. It is the intention, therefore, to be limited as only as indicated to the scope of the claims appended thereto.

1-11. (canceled)

12. A container for storing a liquid containing solids, comprising in combination:
side walls and a funnel shaped bottom wall defining an outlet for the liquid containing solids to be removed from the containers; and
a shut off assembly positioned at the outlet for selectively closing the outlet to maintain the liquid containing solids in the container and for opening the outlet to permit the liquid containing solids to be removed from the container; and
a source of compressed air for introducing a flow path of air through the shut off valve to effect mixing of liquids containing solids when the shut off valve is closed so that the liquid containing solids is homogenously mixed by the air.

13. The container as claimed in claim 12 wherein the shut off assembly includes a flap plate that is constructed and arranged so that the flap plate contains an opening therethrough so that compressed air does not bypass the closing plate when the shut off assembly is in a closed position.

14. The container as claimed in claim 13 wherein the source of compressed air includes a shut off valve for selectively shutting the compressed air off when the shut off mechanism is selectively opened, the shut off valve being disposed upstream of the flap plate on the flow path of air.

15. The container as claimed in claim 12 herein the shut off assembly is a valve that includes a closing flap that is selectively rotated between a closed position and an open position.

16. A container as claimed in claim 15 wherein the plate includes a, circular plate and pivot arms, one of the pivot arms being hollow to allow for the flow of gas therethrough and into the container, the flap plate being disposed in the bottom of the container to prevent the fluid from exiting the container when the flap plate is in a closed position.

17. A container as claimed in claim 16 wherein compressed air is introduced through the elongated opening in a pivot arm through the plate into the container to mix the ingredients in the container when the valve is in a closed position so that the liquid containing solids will be homogenously mixed when the valve is rotated to an open position to permit the liquid to be removed from the container.

18. A flap valve for us in the exit conduit of a container that stores liquids that contain solids, and permits a first flow path of liquid out of the container and second flow path of compressed air into the container, comprising in combination, a first plate for sealing off the exit conduit of the container when it is disposed into a closed position and for allowing fluid to be removed from the container when the plate is disposed in an open position, the plate having a conduit therethrough for permitting compressed air to be introduced through the plate when the plate is in a closed position to permit mixing of the liquid in the container.

19. A flap valve as claimed in claim 18, wherein the plate is supported by two pivot arms that permit the plate to be rotated between an open and closed position, and wherein one of the pivot arms; is tubular so that compressed air can be introduced through the pivot arm and through the flap plate, into the container to effect mixing of the liquid in the container when the plate is disposed in a closed position.

20. A flap valve as claimed in claim 19, wherein the plate includes a cavity in a wall thereof and the opening in the pivot arm extends to the cavity to define a flow path for compressed air to the container when the plate is closed.
